(19) United States
(12) Patent Application Publication
(10) Pub. No.: US 2005/0195821 A1
(43) Pub. Date: Sep. 8, 2005

(54) Method and apparatus for dynamically controlling traffic in wireless station

(75) Inventors: Suk-Jin YUN, Seoul (KR); Jun-whan Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/070,230

(22) Filed: Mar. 3, 2005

Related U.S. Application Data
(60) Provisional application No. 60/549,442, filed on Mar. 3, 2004.

(30) Foreign Application Priority Data
Apr. 13, 2004 (KR) 10-2004-0025413

(51) Int. Cl. H04L 12/28; H04L 12/56

(52) U.S. Cl. 370/392; 370/401; 370/412

(57) ABSTRACT

A method and apparatus dynamically control data traffic, such as multimedia streams, needing a guaranteed Quality of Service (QoS) and normal data traffic, according to a variable communication environment. The method of dynamically controlling traffic in a wireless station includes reading header information of a packet received from an upper layer and determining a type of the packet, setting a priority according to the type of the packet, adjusting a size of a variable buffer by performing appropriate dynamic buffering according to the type of the packet, enqueuing the packet in a fixed buffer if the priority is high and enqueuing the packet in the variable buffer if the priority is low, and transmitting the packet enqueued in the fixed buffer to a destination station prior to the packet enqueued in the variable buffer.

### CROSS-REFERENCE TO RELATED APPLICATIONS

This application claims priority from Korean Patent Application No. 10-2004-0025413 filed on Apr. 13, 2004 in the Korean Intellectual Property Office, and U.S. Provisional Patent Application No. 60/549,442 filed on Mar. 3, 2004 in the United States Patent and Trademark Office, the disclosures of which are incorporated herein by reference in their entirety.

### BACKGROUND OF THE INVENTION

1. Field of the Invention

The present invention relates to a method and apparatus for dynamically controlling traffic in a wireless station, and more particularly, to a method and apparatus for dynamically controlling data traffic such as multimedia streams needing a guaranteed Quality of Service (QoS) and other normal data traffic, according to a variable communication environment.

2. Description of the Related Art

With the widespread use of wireless Local Area Networks (LANs) and the development of home networking, multimedia data transmission has been very important. Thus, the Institute of Electrical and Electronics Engineers (IEEE) 802.11e task group is creating a standard for guaranteeing QoS in Medium Access Control (MC) for wireless LANs. However, it is difficult to allocate priority for QoS in MAC due to a limit to a layered architecture.

According to an IEEE 802.11 standard, two types of priority are determined and transmitted when a payload is transmitted from a Logical Link Control (LLC) layer to a MAC layer. Transmission is performed at the MAC layer using different mechanisms according to the two types of priority. Transmission is performed according to a Point Coordination Function (PCF) in a contention-free mode while transmission is performed according to a Distributed Coordination Function ([DCF) in a contention mode.

However, since priority information regarding a payload transmitted from a transport layer is not known at the LLC layer, the priority information cannot be known at the MAC layer either. Accordingly, for transmission, priority is independently determined at the MAC layer, or it is considered that all payloads transmitted from the LLC layer have the same priority.

In an embodiment of the present invention, Transmission Control Protocol (TCP) congestion control is performed using dynamic buffer management in a MAC for QoS to assist transmission of User Datagram Protocol (UDP) packets. Instead of using priority information transmitted from an upper layer, TCP congestion control is used at the MAC layer so that a greater bandwidth is allocated to multimedia data transmitted over UDP packets.

A layered architecture of the LLC layer, the MAC layer, the upper layer, etc. can be implemented using a well-known Open Systems Interconnection (OSI) 7 layer model. As shown in FIG. 1, a single station 1 includes software modules or hardware modules implementing the 7 layer model. A highest layer (Layer 7), an application layer 10, provides access to an OSI environment and distributed information service for users. A next highest layer (Layer 6), a presentation layer 20, provides independency for application program processing and differences in data representation.

A session layer 30 (Layer 5) provides a configuration for controlling communication between application programs. In other words, the session layer 30 determines how interacting application programs establish and terminate communication therebetween, participate in a process, and manage data. A transport layer 40 (Layer 4) provides reliable and transparent transfer of data between two computers. Transparent transfer means that data from a transmitting party reaches a receiving party without any transforming by any program. Here, the data is recorded in a pure data frame excluding address information, size information, etc. The transport layer 40 is responsible for error recovery and flow control for reliable transport.

A network layer 50 (Layer 3) maintains independence of its upper layers using data transfer and switching technology used to make a system connection. The network layer 50 is responsible for establishment and termination of protocol or firmware communication, participation in a process, and data management.

A data link layer 60 (Layer 2) provides reliable data transfer using a physical connection. The data link layer 60 transmits data necessary for synchronization, error control, and flow control.

A physical layer 70 (Layer 1) is responsible for how an unstructured bitstream is transmitted through a physical medium. The physical layer 70 does not participate in a software transmission process but deals with mechanical, electrical, functional, and formal characteristics of a physical network.

In particular, a station 1 using a TCP and a UDP has a layered architecture shown in FIG. 2. The application layer 10, the presentation layer 20, and the session layer 30 shown in FIG. 1 is included in a single layer, i.e., an upper layer 15 shown in FIG. 2. A transport layer 40 shown in FIG. 2 includes a TCP module 42 processing data complying with the TCP and a UDP module 41 processing data complying with the UDP. In accordance with the transport layer 40 using both of the TCP and the UDP, a network layer is implemented by an Internet Protocol (IP) layer 50 compatible with both of the TCP and the UDP. As described above, a TCP/IP or a UDP/IP is a program including two layers: an upper layer, a TCP or UDP layer, determining a file transmission method; and a lower layer, an IP layer, processing an address of each packet so that the packet accurately reaches its intended destination.

A data link layer 60 is present below the IP layer 50 and includes an LLC layer 61 as an upper layer and a MAC layer 62 as a lower layer. A physical layer 70 is present below the MAC layer 62.

FIG. 3 illustrates a schematic structure of a conventional MAC layer. If a payload is transmitted from an upper layer, an LLC layer 61, to a MAC layer 62, the MAC layer 62 buffers the payload in a data queue 64, makes a payload for managing a MAC, and buffers the made payload in a MAC management queue 63. For synchronization of all MAC data and various managements at a MAC level, a payload in the MAC management queue 63 has priority over a payload in the data queue 64. Payloads in the data queue 64 have the same priority and are transmitted in the order in which they stand in the queue.

As described above, in conventional technology complying with the IEEE 802.11 standard, when an application transmits a payload, priority information regarding the payload is not transmitted. Accordingly, an LLC layer and a MAC layer cannot recognize any priority given to the payload, because a lower layer cannot recognize information that is not specially transmitted from an upper layer in a network having a layered architecture.

If an application is made to transmit priority information regarding a payload to the MAC layer, the application and the MAC layer need to operate as a pair. Imposing such a limit to the variety of applications is not preferable in terms of compatibility. Even though such an application has been developed, if a user uses normal applications, the MAC layer will operate inappropriately.

In addition, since the TCP and the UDP have the same priority for transmission in a conventional wireless LAN MAC, they invade each other's bandwidth when UDP traffic is generated during TCP transmission. As a result, neither the TCP nor the UDP can guarantee reliable transmission.

Consequently, in conventional technology, allocation of priority for providing QoS in data transmission is difficult when a MAC-oriented application is not used. Accordingly, it is difficult to efficiently use wireless media on a network.

Korean Patent No. 312238 discloses technology for data traffic flow control to avoid congestion in a data communications network having a plurality of data traffic sources connected via a transmission link. However, this technology relates to traffic control between nodes and is thus different from the present invention that relates to technology for dynamically controlling traffic in a single node according to a type of transmission protocol.

### SUMMARY OF THE INVENTION

The present invention provides a method and apparatus for allocating different priorities to data transmitted according to a transmission protocol for real-time streaming (e.g., a User Datagram Protocol ((UDP)) and data transmitted according to a normal data transmission protocol (e.g., a Transmission Control Protocol (TCP)) at a Medium Access Control (MAC) layer within a wireless communication station and for storing the data transmitted according to the different protocols in different buffers.

The present invention also provides a method and apparatus for dynamically adjusting a size of a buffer storing normal data when an amount of entire data transmitted at a MAC layer increases.

The present invention also provides a method and apparatus for decreasing a TCP sliding window size at a transport layer when real-time streaming data is transmitted so that the real-time streaming data is efficiently transmitted.

The present invention also provides a method and apparatus for transmitting real-time streaming data without backoff so that real-time streaming is efficiently provided.

According to an aspect of the present invention, there is provided a method of dynamically controlling traffic in a wireless station, the method including reading header information of a packet received from an upper layer and determining a type of the packet; setting a priority according to the type of the packet; adjusting a size of a variable buffer by performing appropriate dynamic buffering according to the type of the packet; enqueuing the packet in a fixed buffer if the priority is high and enqueuing the packet in the variable buffer if the priority is low; and transmitting the packet enqueued in the fixed buffer to a destination station prior to the packet enqueued in the variable buffer.

The type of the packet is preferably, but not necessarily, a User Datagram Protocol (UDP) or a Transmission Control Protocol (TCP), and the UDP has priority over the TCP.

The type of the packet may be identified from information recorded in a protocol number field in an Internet Protocol (IP) header.

When the type of the packet is the UDP, adjusting a size of a variable buffer may comprise comparing a number of consecutive non-TCP packets with a predetermined first threshold, and adjusting the size of the variable buffer according to a result of the comparison. Here, the adjusting the size of the variable buffer may comprise minimizing the size of the variable buffer when the number of consecutive non-TCP packets is greater than or equal to the predetermined first threshold, and decreasing the size of the variable buffer by one unit when the number of consecutive non-TCP packets is less than the predetermined first threshold.

When the type of the packet is the TCP, adjusting a size of a variable buffer may comprise comparing a number of consecutive non-UDP packets with a predetermined second threshold, and adjusting the size of the variable buffer according to a result of the comparison. Here, adjusting the size of the variable buffer may comprise increasing the size of the variable buffer by one unit when the number of consecutive non-UDP packets is greater than or equal to the predetermined second threshold, and discarding the TCP packet that cannot be accommodated by the variable buffer when the number of consecutive non-UDP packets is less than the predetermined second threshold.

The discarding of the TCP packet may comprise decreasing a size of a sliding window and thus decreasing an amount of TCP traffic.

The method may further comprise receiving an acknowledgement (ACK) frame corresponding to the packet from the destination station, and equeuing a packet stored in the fixed buffer in a Medium Access Control (MAC) transmission buffer and enqueuing a packet stored in the variable buffer in the MAC transmission buffer when the fixed buffer has no packets to be transmitted.

The transmitting of the packet may comprise immediately transmitting the packet enqueued in the fixed buffer to a physical layer without backoff and transmitting the packet enqueued in the variable buffer to the physical layer after holding the packet for a predetermined backoff time, and converting digital data included in the packet received by the physical layer into an analog radio frequency (RF) signal and transmitting the analog RF signal to another station through a wireless medium.

In accordance with another aspect of the present invention, there is provided a wireless station for dynamically controlling traffic, the wireless station comprising a priority bit setting unit reading header information of a packet received from an upper layer, determining a type of the packet, and setting a priority according to the type of the packet, a dynamic buffering unit adjusting a size of a variable buffer by performing appropriate dynamic buffering according to the type of the packet, a fixed buffer in which a packet having high priority is enqueued, a variable buffer in which a packet having low priority is enqueued, and a unit transmitting the packet enqueued in the fixed buffer to a destination station prior to the packet enqueued in the variable buffer.

When the type of the packet is the UDP, the dynamic buffering unit preferably compares a number of consecutive non-TCP packets with a predetermined first threshold, and adjusts the size of the variable buffer according to a result of the comparison.

Here, the dynamic buffering unit preferably adjusts the size of the variable buffer by minimizing the size of the variable buffer when the number of consecutive non-TCP packets is greater than or equal to the predetermined first threshold, and decreasing the size of the variable buffer by one unit when the number of consecutive non-TCP packets is less than the predetermined first threshold.

When the type of the packet is the TCP, the dynamic buffering unit preferably compares a number of consecutive non-UDP packets with a predetermined second threshold, and adjusts the size of the variable buffer according to a result of the comparison.

The dynamic buffering unit preferably adjusts the size of the variable buffer by increasing the size of the variable buffer by one unit when the number of consecutive non-UDP packets is greater than or equal to the predetermined second threshold, and discarding the TCP packet that cannot be accommodated by the variable buffer when the number of consecutive non-UDP packets is less than the predetermined second threshold.

The wireless station may further comprise a TCP module that decreases a size of a sliding window by discarding the TCP packet and thus decreases an amount of TCP traffic.

Also, the wireless station may further comprise a backoff determiner that receives an acknowledgement (ACK) frame corresponding to the packet from the destination station, and equeuing a packet stored in the fixed buffer in a Medium Access Control (MAC) transmission buffer and enqueuing a packet stored in the variable buffer in the MAC transmission buffer when the fixed buffer has no packets to be transmitted.

In the wireless station, the transmitting unit comprises a lower MAC module immediately transmitting the packet enqueued in the fixed buffer to a physical layer without backoff and transmitting the packet enqueued in the variable buffer to the physical layer after holding the packet for a predetermined backoff time, and a physical layer module converting digital data included in the packet received by the physical layer into an analog radio frequency (RF) signal and transmitting the analog RF signal to another station through a wireless medium.

### BRIEF DESCRIPTION OF THE DRAWINGS

The above and other features and advantages of the present invention will become more apparent by describing in detail preferred embodiments thereof with reference to the attached drawings in which:

FIG. 1 illustrates an Open Systems Interconnection (OSI) 7 layer model;

FIG. 2 illustrates a layered architecture of a station that communicates using a Transmission Control Protocol (TCP) and a User Datagram Protocol (UDP);

FIG. 3 illustrates a schematic structure of a conventional Medium Access Control (MAC) layer;

FIG. 4 illustrates a layered architecture according to an embodiment of the present invention;

FIG. 5 is a block diagram of an upper MAC module according to an embodiment of the present invention;

FIG. 6 is a block diagram of a lower MAC module according to an embodiment of the present invention;

FIGS. 7 and 8 are flowcharts illustrating operations performed by the upper MAC module shown in FIG. 5;

FIG. 9 is a detailed flowchart of UDP dynamic buffering according to an embodiment of the present invention;

FIG. 10 is a detailed flowchart of TCP dynamic buffering according to an embodiment of the present invention;

FIG. 11 is a flowchart of a procedure for enqueuing a MAC Protocol Data Unit (MPDU) in a MAC transmission buffer (MacTxQ) when a station receives an acknowledgement (ACK) frame from another station; and

FIG. 12 is a flowchart of a last procedure for quality of service (QoS) performed in the lower MAC module shown in FIG. 6.

### DETAILED DESCRIPTION OF THE INVENTION

The present invention will now be described more fully with reference to the accompanying drawings, in which preferred embodiments of this invention are shown. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

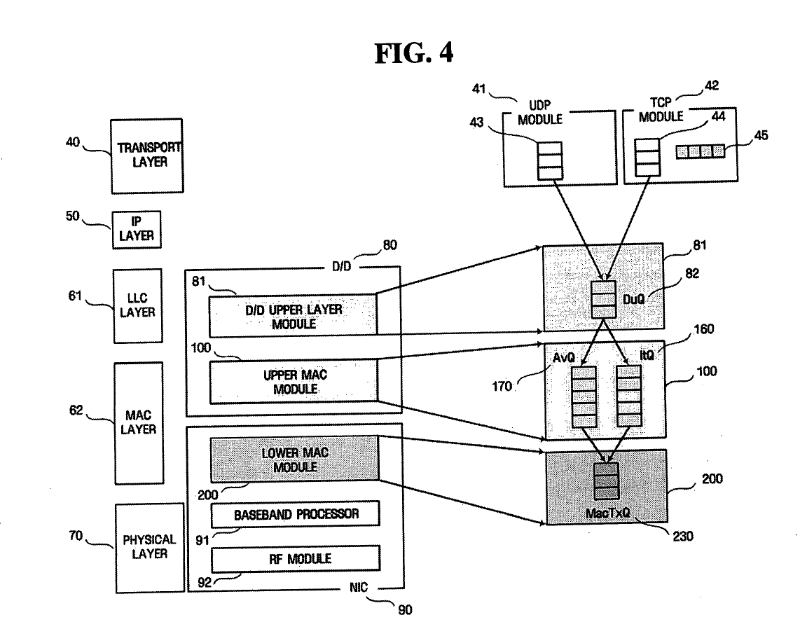

FIG. 4 illustrates a layered architecture according to an embodiment of the present invention. A transport layer 40 includes a User Datagram Protocol (UDP) module 41 and a Transmission Control Protocol (TCP) module 42. The UDP module 41 includes a UDP socket buffer 43. The TCP module 42 includes a TCP socket buffer 44 and a variable sliding window 45.

An Internet Protocol (IP) layer 50 uses major Internet transport layer protocols, i.e., a TCP and a UDP to transmit data through a network. An IP header includes a protocol number field used to designate a type of transport layer 40 that transmits data. For example, the protocol number field informs whether data transmitted from the transport layer 40 is UDP data or TCP data. Accordingly, an IP layer in a destination station can receive data using appropriate transmission protocol software.

After connection is established, the TCP exactly transmits data to a destination without loss or redundancy. Each segment of the data is transmitted together with a checksum based on which received data is checked for reliable data receipt. A transmitter wants to receive an acknowledgement (ACK) of each segment of the data and re-transmits the segment of the data if it does not receive the ACK within a predetermined period of time.

The TCP provides a view based on a byte stream of a communication application. TCP software in an endpoint recombines the segments into a data stream and transmits the data stream to software of an application level. Unlike the UDP transmitting data in discontinuous size, the TCP does not provide a physical boundary between transmitted data.

Meanwhile, the UDP can transmit data in discontinuous size and does not require a checksum and frame numbering, thereby having low data overhead. Accordingly, the UDP is suitable to transmission of media streams in a wireless Local Area Network (LAN) environment.

The UDP has a very simple format and provides a high-quality interface to datagram-delivery facilities for an IP. Since the UDP transmits data without guarantee of delivery, an upper stage in software bears the responsibility of guaranteed delivery when data reliability is required. The UDP is recognized as having low overhead in terms of protocol control information regarding transmission data and being better than a substitute protocol, i.e., the TCP, in terms of efficiency. Accordingly, the UDP is suitable to a LAN environment. For this reason, the UDP is usually used in local area applications.

Usually, since users access networks through application-level services, it is obvious which of the UDP and the TCP is selected. An operating mode of a server is different depending upon a type of transmission protocol. Servers using the UDP usually perform repetitive operations. In other words, these servers process requested events only and do not provide service for other requests until the current events are completely processed.

Consequently, the TCP is suitable to data (e.g., text files and graphic files) that do not require guarantee of continuity in a data flow, and the UDP is suitable to data (e.g., media streams) requiring the guarantee of continuity in a data flow. In an embodiment of the present invention, multimedia data requiring real-time streaming in an application is transmitted using the UDP, and other normal data is transmitted using the TCP. However, the present invention is not restricted thereto. It will be easily understood by those skilled in the art that any transmission protocol other than the UDP may be used if it is suitable to real-time streaming and any transmission protocol other than the TCP may be used if it is suitable to transmission of normal data.

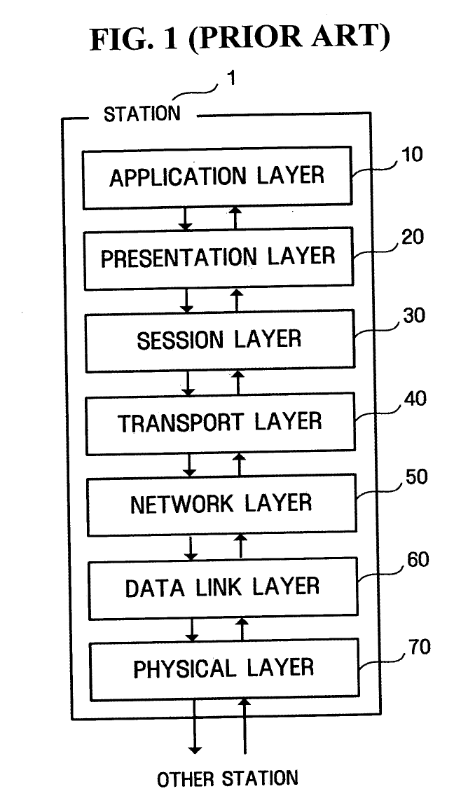

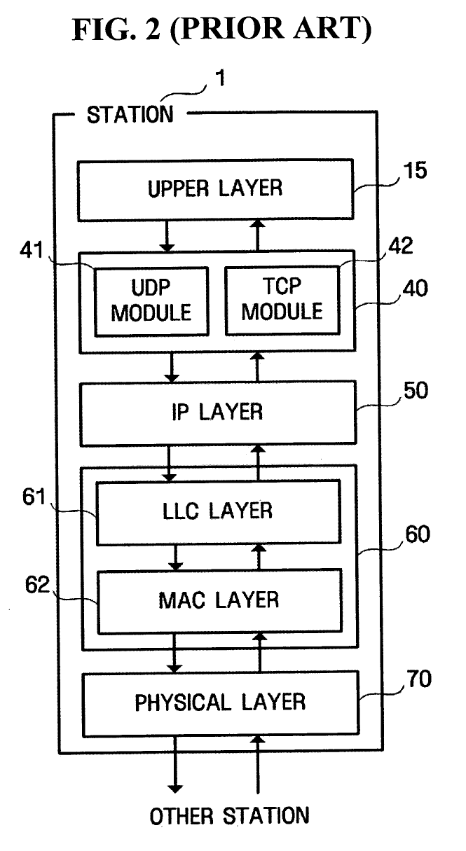

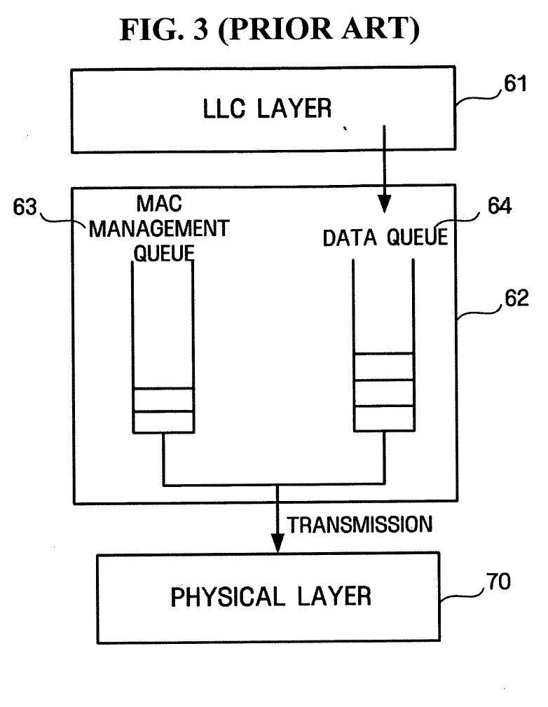

Referring to FIG. 4, the sliding window 45 included in the TCP module 42 is used to control a packet flow between two computers or network hosts according to the TCP in the Internet. In the TCP, all of the transmitted data should be confirmed by a receiving host. However, the sliding window 45 allows a plurality of data packets to be confirmed by only a single confirmation. The TCP socket buffer 44 allows the TCP to receive and process data independently of an upper layer, i.e., an application layer 10 (shown in FIG. 1). In other words, while the application layer processes data at a predetermined speed, the TCP module 42 can read the data in advance using the TCP socket buffer 44.

When an ACK frame with respect to data is not received from the receiving host within a predetermined period of time, a size of the sliding window 45 is reduced to decrease transmission throughput, and the data whose transmission failed is re-transmitted. Data retransmission occurs mainly because the data has not been normally transmitted to the receiving host. However, data retransmission may sometimes occur because the receiving host does not transmit the ACK frame even if it normally receives the data or because a transmitting host does not transmit the ACK frame to an upper layer, i.e., the transport layer 40, even if it receives the ACK frame from the receiving host.

A Medium Access Control (MAC) layer 62 is an essential part of the present invention and includes an upper MAC module 100 and a lower MAC module 200. The upper MAC module 100 can be appropriately implemented in software and has non-time-critical MAC functions. The lower MAC module 200 can be appropriately implemented in hardware and has time-critical MAC functions.

A physical layer 70 receives a MAC Protocol Data Unit (MPDU) transmitted from the MAC layer 62, generates a Packet Protocol Data Unit (PPDU), and generates and transmits a radio signal including the PPDU. The physical layer 70 may include a baseband processor 91 and a Radio Frequency (RF) module 92.

In view of software and hardware, a device driver (D/D) 80 is software and includes a D/D upper layer module 81 corresponding to a Logical Link Control (LLC) layer 61 and the upper MAC module 100. The D/D upper layer module 81 may be implemented by a Network Driver Interface Specification (NDIS) providing a standard interface for drivers of a Network Interface Card (NIC) 90. The NDIS is standardized by Microsoft and 3COM and is supported by many NIC manufacturers. To match a packet output from a driver of the NIC 90 with an appropriate stack, the NDIS polls stacks one by one until a stack requires a packet. The NIC 90 is hardware and may include the lower MAC module 200, the baseband processor 91, and the RF module 92. General examples of modules implemented in software and hardware, respectively, have been given above. However, the present invention is not restricted thereto, and modules may be differently implemented according to the necessities of users and the trends in the industry. Accordingly, it is meaningless to strictly distinguish software and hardware. It is reasonable to use the term “module” implementing a particular function.

The D/D upper layer module 81 includes a buffer (hereinafter, referred to as a DuQ) 82 that temporarily stores data, which has been received from an upper layer, before being transmitted to a lower layer, i.e., the MAC layer 62.

The upper MAC module 100 stores data received from the D/D upper layer module 81 in different buffers according to types of the data. A buffer referred to as an AvQ 170 temporarily stores real-time data, e.g., multimedia stream data. Another buffer referred to as an ItQ 160 temporarily stores normal data, e.g., Internet data, File Transfer Protocol (FTP) data, and Telnet data. The upper MAC module 100 gives priority to the AvQ 170 over the ItQ 160 taking into account characteristics of real-time data when transmitting data. In an embodiment of the present invention, multimedia data is transmitted using the UDP and other normal data is transmitted using the TCP.

The lower MAC module 200 includes a MAC transmission buffer (hereinafter, referred to as a MacTxQ) 230 that temporarily stores an MPDU received from the upper MAC module 100 such that the MPDU is provided at a request of a lower layer, i.e., the physical layer 70. The two buffers, i.e., the AvQ 170 and the ItQ 160 in the upper MAC module 100 are integrated into a single buffer, i.e., the MacTxQ 230 in the lower MAC module 200. The MacTxQ 230 sequentially transmits frames incoming from the upper MAC module 100. However, whether to apply backoff is determined according to a priority given to each frame.

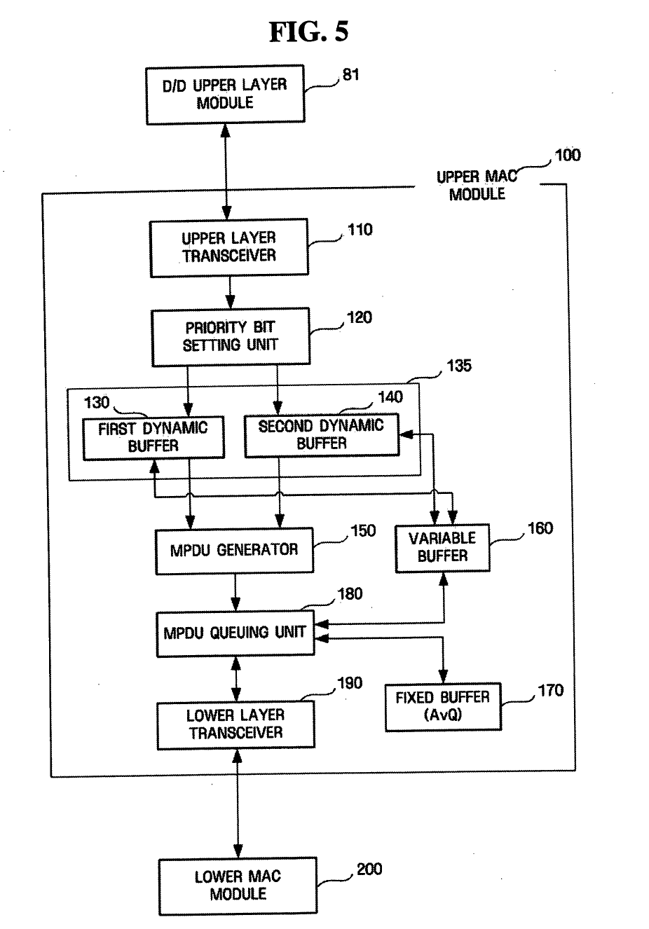

FIG. 5 is a block diagram of the upper MAC module 100 according to an embodiment of the present invention. The upper MAC module 100 may include an upper layer transceiver 110, a priority bit setting unit 120, a dynamic buffering unit 135, an MPDU generator 150, an MPDU queuing unit 180, a variable buffer 160 corresponding to the ItQ, a fixed buffer 170 corresponding to the AvQ, and a lower layer transceiver 190.

The upper layer transceiver 110 transmits data to and receives data from the LLC layer 61.

The priority bit setting unit 120 reads a protocol number field recorded in an IP header of a received packet and determines whether the packet is a TCP type or a UDP type. When the packet is determined to be the UDP type, the priority bit setting unit 120 sets a priority bit as “Av_traffic.” When the packet is determined to be the TCP type, the priority bit setting unit 120 sets the priority bit as “It_traffic.”

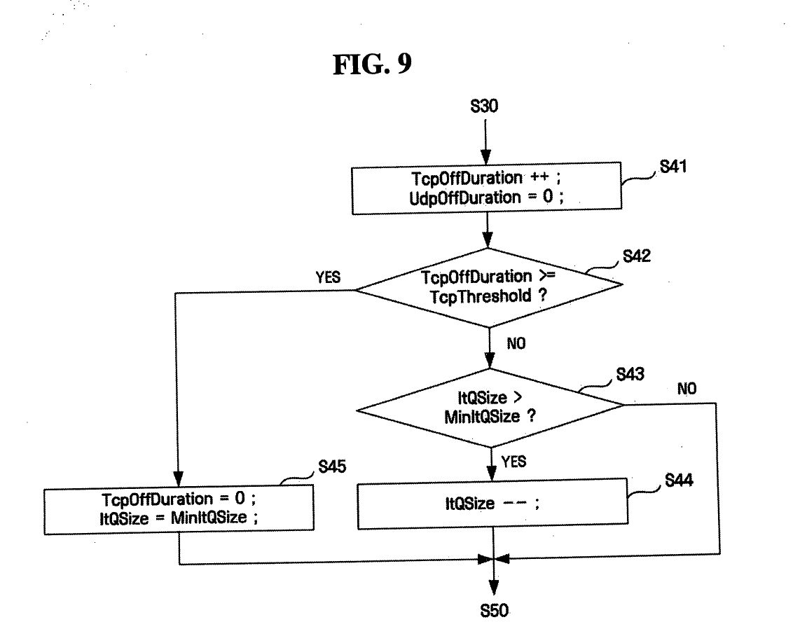

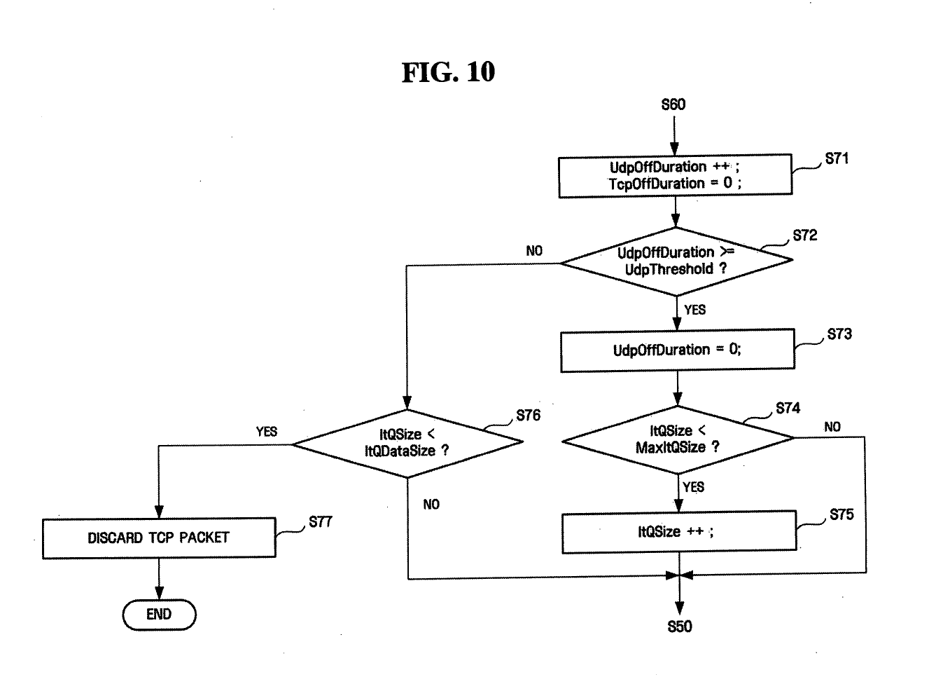

The dynamic buffering unit 135 includes a first dynamic buffer 130 and a second dynamic buffer 140 and performs appropriate dynamic buffering according to the type of the packet to adjust a size of the variable buffer 160. When receiving a UDP packet, the first dynamic buffer 130 performs “UDP dynamic buffering” by comparing a number of consecutive non-TCP packets with a predetermined first threshold, referred to as a TcpThreshold, and adjusting a size of the variable buffer 160 according to a result of the comparison. The UDP dynamic buffering will be described in detail later with reference to FIG. 9. When receiving a TCP packet, the second dynamic buffer 140 performs “TCP dynamic buffering” by comparing a number of consecutive non-UDP packets with a predetermined second threshold, referred to as a UdpThreshold, and adjusting the size of the variable buffer 160 according to a result of the comparison. The TCP dynamic buffering will be described in detail later with reference to FIG. 10.

The MPDU generator 150 generates an MPDU by attaching a MAC header and a tail to the packet received from the LLC layer 61 via the upper layer transceiver 110.

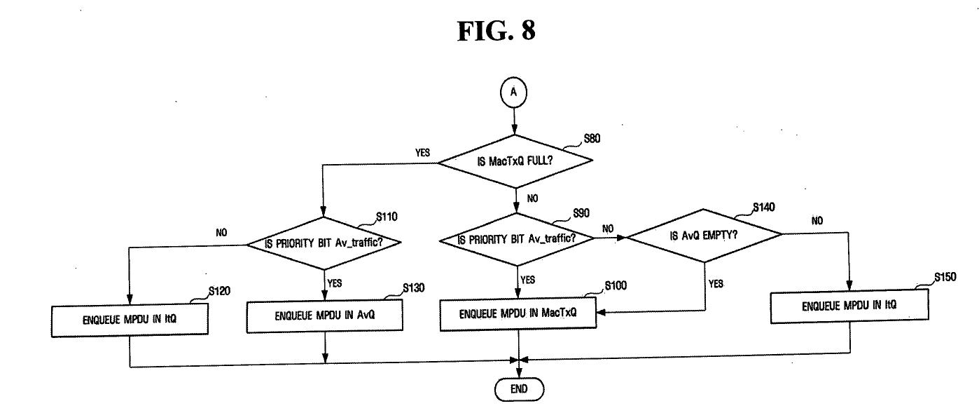

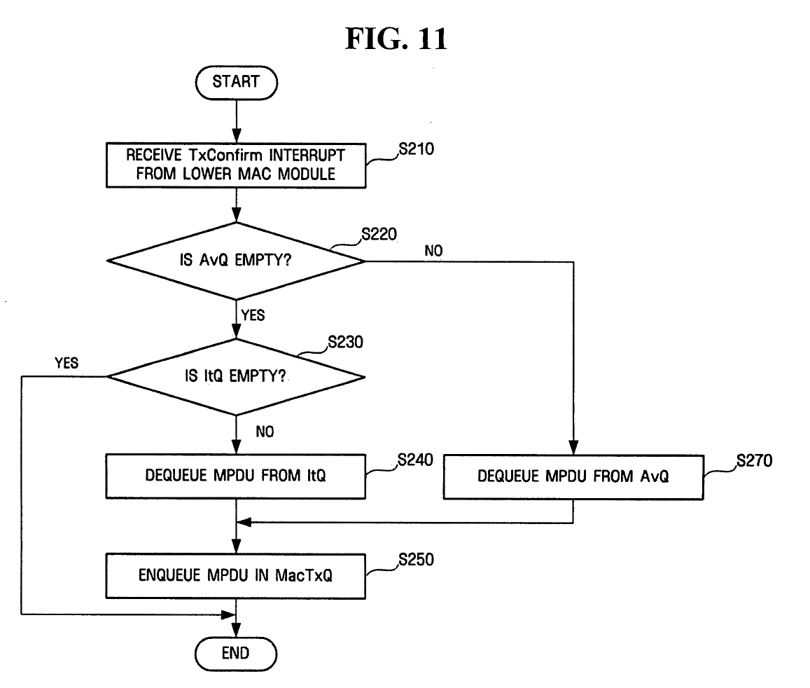

The MPDU queuing unit 180 determines a buffer in which the generated MPDU is to be queued, based on the priority bit and whether the MacTxQ 230 in the lower MAC module 200 is full, and queues the MPDU into the determined buffer. These operations of the MPDU queuing unit 180 will be described in detail later with reference to FIG. 8. Upon receiving from the lower MAC module 200 a TxConfirm interrupt reporting that an ACK frame has been normally received, the MPDU queuing unit 180 determines whether to enqueue an MPDU temporarily stored in the variable buffer 160 or the fixed buffer 170 in the MacTxQ 230, based on whether either of the buffers 160 and 170 is completely empty, dequeues the MPDU from either of the buffers 160 and 170, and enqueues the MPDU in the MacTxQ 230. These operations of the MPDU queuing unit 180 will be described in detail later with reference to FIG. 11.

The variable buffer 160 temporarily stores an MPDU including normal data such as TCP-type data that does not require QoS and has a variable size according to adjustment by either of the first and second dynamic buffers 130 and 140. The fixed buffer 170 temporarily stores an MPDU including multimedia stream data such as UDP-type data that requires QoS.

The lower layer transceiver 190 transmits data to and receives data from the lower MAC module 200.

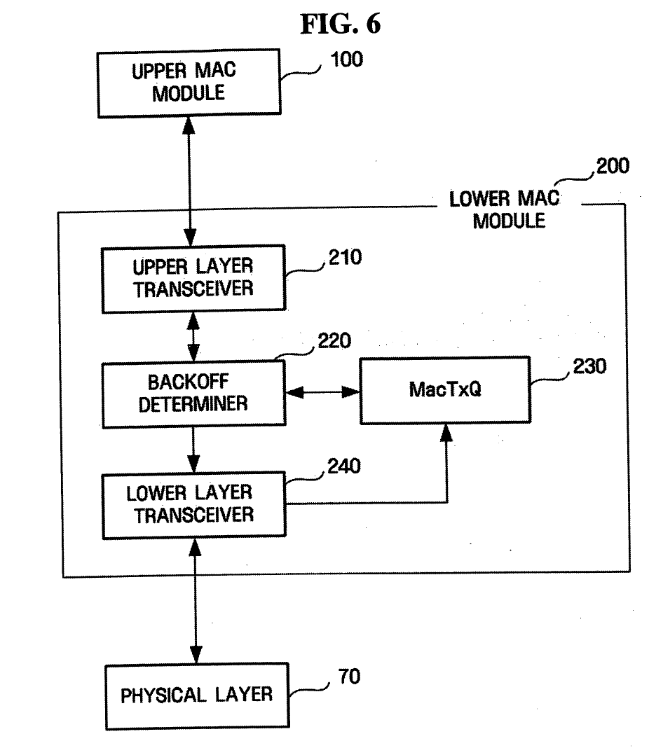

FIG. 6 is a block diagram of the lower MAC module 200 according to an embodiment of the present invention. The lower MAC module 200 may include an upper layer transceiver 210, a backoff determiner 220, a MacTxQ 230, and a lower layer transceiver 240.

The upper layer transceiver 210 transmits data to and receives data from the upper MAC module 100.

The backoff determiner 220 determines whether to apply backoff based on the priority bit determined and transmitted by the upper MAC module 100. In detail, the backoff determiner 220 extracts an MPDU from the MacTxQ 230 and transmits the extracted MPDU to the physical layer 70 without backoff when the priority bit is Av_traffic. However, when the priority bit is It_traffic, the backoff determiner 220 stands by for a predetermined backoff time according to a predetermined backoff algorithm (e.g., random backoff) and then transmits the extracted MPDU to the physical layer 70.

The MacTxQ 230 stores MPDUs in order and provides the MPDUs to the physical layer 70 in order that the MPDUs have been stored.

The lower layer transceiver 240 transmits data to and receives data from the physical layer 70.

All elements shown in FIGS. 5 and 6 may be defined as “modules.” A module indicates software or a hardware element such as a Field Programmable Gate Array (FPGA) or an Application Specific Integrated Circuit (ASIC) and performs a particular function. However, the module is not restricted to software or hardware. The module may be designed and included in an addressable storage medium or may be designed to execute one or more processors. Accordingly, modules may include software elements, object-oriented software elements, class elements, task elements, processors, functions, attributes, procedures, sub-routines, segments of program codes, drivers, firmware, micro codes, circuits, data, databases, data structures, tables, arrays, and parameters. A function provided by elements and modules may be integrated into a less number of elements and a less number of modules or may be divided into a more number of elements and a more number of modules. In addition, elements and modules may be implemented to execute one ore more computers within a communication system.

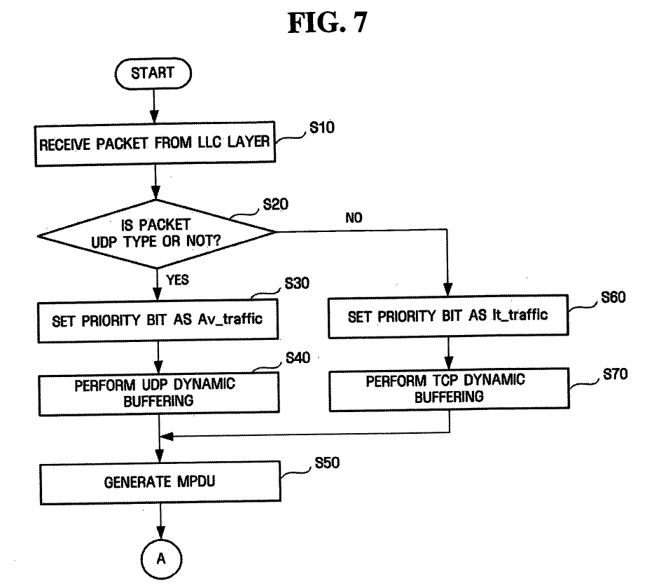

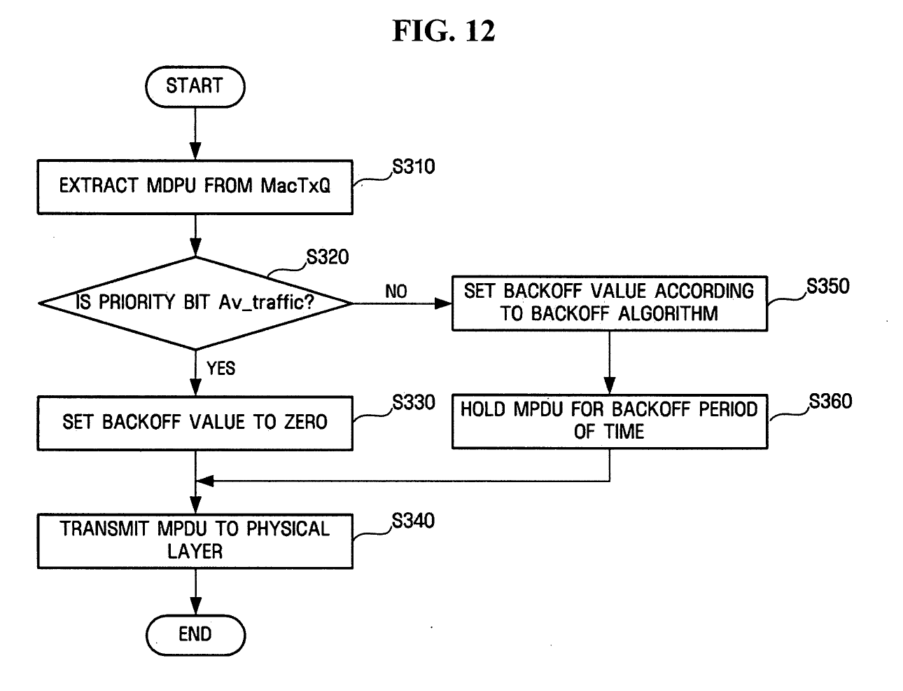

In embodiments of the present invention, two procedures are provided to support QoS. FIGS. 7 through 11 illustrate a first procedure for filtering traffic coming down from an upper layer according to a dynamic buffering algorithm designed in the upper MAC module 100 and separately storing data into the two buffers 160 and 170 according to packet characteristics based on a result of the filtering. FIG. 12 illustrates a second procedure for transmitting an MPDU received from the upper MAC module 100 with QoS.

FIGS. 7 and 8 are flowcharts illustrating operations performed by the upper MAC module 100. The operations determine whether to buffer packets received from the LLC layer 61 according to the dynamic buffering algorithm (see FIGS. 9 and 10) designed in the upper MAC module 100 and determines a queue in which the packets are stored.

Referring to FIG. 7, the upper layer transceiver 110 in the upper MAC module 100 receives a packet from the LLC layer 61 in operation S10. The priority bit setting unit 120 reads a protocol number field recorded in an IP header of the received packet and determines whether the packet is the TCP type or the UDP type in operation S20. Although an LLC header is attached in front of an IP header of data transmitted from the upper MAC module 100, since the LLC header has a fixed length, a protocol number can be read by reading a value at a predetermined offset position.

When the packet is determined as the UDP type, the priority bit setting unit 120 sets a priority bit as “Av_traffic” in operation S30. The priority bit may have a value of 1 or 0, and is stored in memory as a parameter value included in a data structure accompanied with a particular packet and then used in the operations of the upper or lower MAC module 100 or 200.

Next, the first dynamic buffer 130 performs the UDP dynamic buffering to adjust the size of the variable buffer, i.e., ItQ 160 in operation S40. The UDP dynamic buffering will be described in detail with reference to FIG. 9 later. Thereafter, the MPDU generator 150 generates an MPDU by attaching a MAC header and a tail to the packet in operation S50.

Meanwhile, when the packet is determined as the TCP type, the priority bit setting unit 120 sets a priority bit as “It_traffic” in operation S60. When the “Av_traffic” is set to 1, the “It_traffic” will be set to 0. Conversely, when the “Av_traffic” is set to 0, the “It_traffic” will be set to 1.

Next, the second dynamic buffer 140 performs the TCP dynamic buffering to adjust the size of the ItQ 160 in operation S70. The TCP dynamic buffering will be described in detail with reference to FIG. 10 later. Thereafter, an MPDU is generated in operation S50 in the same manner as described above.

FIG. 8 is a flowchart of operations performed by the MPDU queuing unit 180 in the upper MAC module 100. After operation S50, the MPDU queuing unit 180 determines whether the MacTxQ 230 is full in operation S80. If the MacTxQ 230 is not full, it is determined whether the priority bit is the “Av_traffic” in operation S90. If it is determined that the priority bit is the “Av_traffic,” the MPDU generated by the MPDU generator 150 is enqueued in the MacTxQ 230 in operation S100.

If it is determined that the priority bit is the “It_traffic,” i.e., the priority bit is not the “Av_traffic” in operation S90, it is determined whether the AvQ 170 is completely empty in operation S140. If it is determined that the AvQ 170 is completely empty, the MPDU generated by the MPDU generator 150 is enqueued in the MacTxQ 230 in operation S100. If it is determined that the AvQ 170 is not completely empty in operation S140, this means that the AvQ 170 stores an MPDU to be transmitted. Accordingly, since the MPDU stored in the AvQ 170 has priority over the MPDU generated by the MPDU generator 150, the MPDU generated by the MPDU generator 150 is enqueued in the ItQ 160 in operation S150, and the MPDU stored in the AvQ 170 is enqueued in the MacTxQ 230.

If it is determined that the MacTxQ 230 is full in operation S80, the MPDU generated by the MPDU generator 150 cannot be enqueued in the MacTxQ 230, and thus it is determined whether the priority bit is the “Av_traffic” in operation S110. If it is determined that the priority bit is the “Av_traffic,” the MPDU generated by the MPDU generator 150 is enqueued in the AvQ 170 in operation S130.

If it is determined that the priority bit is the “It_traffic,” i.e., the priority bit is not the “Av_traffic” in operation S110, the MPDU generated by the MPDU generator 150 is enqueued in the ItQ 160 in operation S120.

A dynamic buffering procedure illustrated in FIG. 7 is divided into the UDP dynamic buffering (S40) and the TCP dynamic buffering (S70) according to a type of a received packet. The size of the ItQ 160 is changed according an increase or a decrease in the number of UDP packets. The dynamic buffering procedure will be described in detail with reference to FIGS. 9 and 10 below.

FIG. 9 is a detailed flowchart of the UDP dynamic buffering in operation S40. When the upper MAC module 100 receives a UDP packet from the LLC layer 61, the UDP dynamic buffering (S40) is performed as follows. The UDP dynamic buffering is relatively simple as compared to the TCP dynamic buffering (S70) because UDP packets have priority over TCP packets and are thus under a situation where they are held in standby status, due to TCP traffic, less than TCP packets.

Upon receiving the UDP packet, a parameter (hereinafter, referred to as a “TcpOffDuration”) indicating a number of consecutive non-TCP packets is increased by 1, and a parameter (hereinafter, referred to as a “UdpOffDuration”) indicating a number of consecutive non-UDP packets is initialized to 0 in operation S41. If a value of the TcpOffDuration is greater than or equal to a predetermined threshold (referred to as a “TcpThreshold”) in operation S42, the value of TcpOffDuration is initialized to 0 and a parameter (hereinafter, referred to as an “ItQSize”) indicating the size of the ItQ 160 is set to a minimum ItQ size (hereinafter, referred to as a “MinItQSize”) in operation S45. A value of the TcpThreshold may vary with a user's necessity.

The value of the TcpOffDuration greater than the TcpThreshold indicates that a TCP packet has not been received for a long period of time. Accordingly, TCP traffic can be reduced by minimizing the size of the ItQ 160. When the size of the ItQ 160 storing TCP packets is minimized, an occasionally received TCP packet is intentionally discarded due to insufficient storage space. Then, the TCP module 42 in the transport layer 40 determines that an error has occurred during transmission of the TCP packet and decreases the size of the sliding window 45. Consequently, TCP traffic is reduced.

The MinItQSize and a maximum ItQ size (hereinafter, referred to as a “MaxItQSize”) are predetermined according to system performance of a wireless communication terminal and a network environment. For example, when the MinItQSize is set to 1 and the MaxItQSize is set to 16, the size of the ItQ 160 may have a value among 1 through 16. A size unit may have a magnitude for storing a single MPDU. Accordingly, one more MPDU can be stored or cannot be stored by increasing or decreasing, respectively, the size unit by one. If it is determined that the value of the TcpOffDuration is less than the TcpThreshold in operation S42, it is determined whether a value of the ItQSize is greater than a value of the MinItQSize in operation S43. If it is determined that the value of the ItQSize is greater than the value of the MinItQSize, the value of the ItQSize is decreased by 1 in operation S44. However, if it is determined that the value of the ItQSize is not greater than the value of the MinItQSize, the value of the ItQSize is equal to the value of the MinItQSize and thus cannot be decreased any more. Accordingly, operation S44 is skipped.

FIG. 10 is a detailed flowchart of the TCP dynamic buffering in operation S70. When the upper MAC module 100 receives a TCP packet from the LLC layer 61, the TCP dynamic buffering (S70) is performed as follows.

Upon receiving the TCP packet, the value of UdpOffDuration is increased by 1, and the value of the TcpOffDuration is initialized to 0 in operation S71. If the value of the UdpOffDuration is greater than or equal to a predetermined threshold (referred to as a “UdpThreshold”) in operation S72, the value of the UdpOffDuration is initialized to 0 in operation S73. A value of the UdpThreshold may vary with the user's necessity.

Next, it is determined whether the value of the ItQSize is less than a value of the MaxItQSize in operation S74. If it is determined that the value of the ItQSize is less than the value of the MaxItQSize, the value of the ItQSize is increased by 1 in operation S75. However, if it is determined that the value of the ItQSize is not less than the value of the MaxItQSize, the value of the ItQSize is equal to the value of the MaxItQSize, and therefore, operation S75 is skipped.

The value of the UdpOffDuration greater than the value of the UdpThreshold indicates that a UDP packet has not been received for a long period of time. Accordingly, the TCP traffic may be increased by increasing the ItQSize.

Meanwhile, when it is determined that the value of the UdpOffDuration is less than the value of the UdpThreshold in operation S72, it is determined whether the value of the ItQSize is less than a value of ItQDataSize in operation S76. When the value of the ItQSize is less than the value of the ItQDataSize, the ItQ 160 does not have enough space to store the currently received TCP packet, and thus the current TCP is discarded in operation S77, and the procedure ends. Then, the TCP module 42 in the transport layer 40 decreases the size of the sliding window 45, thereby decreasing TCP traffic. If it is determined that the value of the ItQSize is not less than the value of the ItQDataSize in operation S76, the procedure goes to operation S50. The value of the ItQDataSize indicates the sum of a TCP packet that has been stored in the ItQ 160 and the current TCP packet.

FIG. 11 is a flowchart of a procedure for enqueuing an MPDU in the MacTxQ 230 when a station receives an ACK frame from another station. An MPDU that has been transmitted from one station to another station is buffered in the MacTxQ 230 in the one station until the one station receives an ACK frame from the another station. In response to the ACK frame, the MPDU is removed from the MacTxQ 230. At this time, the MacTxQ 230 has an empty space. Accordingly, if there is an MPDU in either of the AvQ 170 and the ItQ 160 included in the upper MAC module 100, the MPDU is enqueued in the MacTxQ 230. Here, the AvQ 170 has priority over the ItQ 160. An algorithm for giving priority to the AvQ 170 over the ItQ 160 will be described below.

When the station 1 receives from another station an ACK frame corresponding to data that the station 1 has transmitted to the other station, the upper MAC module 100 in the station 1 receives a TxConfirm interrupt, which indicates that the ACK frame has been normally received, from the lower MAC module 200 through the lower layer transceiver 190 in operation S210.

Then, the MPDU queuing unit 180 determines whether the AvQ 170 is completely empty in operation S220. If the AvQ 170 is determined to be completely empty, the MPDU queuing unit 180 determines whether the ItQ 160 is completely empty in operation S230. If the ItQ 160 is determined to be completely empty, the algorithm ends since there is no MPDU to be transmitted from the upper MAC module 100 to the lower MAC module 200.

If it is determined that the ItQ 160 is not completely empty in operation 230, that is, if there is an MPDU stored in the ItQ 160, the MPDU is dequeued from the ItQ 160 and enqueued in the MacTxQ 230 in operations S240 and S250. Meanwhile, if it is determined that the AvQ 170 is not completely empty in operation S220, that is, if there is an MPDU in the AvQ 170, the MPDU is dequeued from the AvQ 170 and is enqueued in the MacTxQ 230 in operation S270 and S250.

FIG. 12 is a flowchart of a last procedure for QoS performed in the lower MAC module 200. The lower MAC module 200 determines whether to apply backoff based on a priority bit determined and transmitted by the upper MAC module 100. Whether to apply the backoff is very essential since time consumed due to the backoff exerts a greatest influence on data transmission efficiency.

With reference to an MPDU received from the upper MAC module 100, the lower MAC module 200 determines whether to apply backoff to the MPDU. If the MPDU has Av_traffic as a priority bit, the upper MAC module 100 transmits the MPDU without backoff, thereby occupying a channel with priority over other stations present in a current Basic Service Set (BSS) and quickly transmitting the MPDU. If the MPDU has It_traffic as the priority bit, the lower MAC module 200 transmits the MPDU according to Carrier Sense Multiple Access/Collision Avoidance like the other stations.

Referring to FIG. 12, an MPDU is extracted from the MacTxQ 230 according to order in which the MPDU has been enqueued in the MacTxQ 230 in operation S310. It is determined whether a priority bit of the extracted MPDU is Av_traffic in operation S320. The priority bit can be identified by reading a parameter value indicating the priority bit within a data structure additionally transmitted from the upper MAC module 100 together with the MPDU.

If it is determined that the priority bit is Av_traffic, the lower MAC module 200 sets a backoff value to “0” in operation S330 and immediately transmits the MPDU to the physical layer 70 in operation S340. If it is determined that the priority bit is not Av_traffic in operation S320, that is, if the priority bit is It traffic, the lower MAC module 200 sets the backoff value according to a backoff algorithm (e.g., a random backoff algorithm) in operation S350, then holds the MPDU for a backoff time corresponding to the backoff value in operation S360, and then transmits the MPDU to the physical layer 70 in operation S340.

The physical layer 70 generates a PPDU using the MPDU received from the lower MAC module 200, converts digital data included in the PPDU into an analog RF signal, and transmits the analog RF signal to another station through a wireless medium.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

According to the present invention, a bandwidth of normal data is dynamically reduced when data traffic (e.g., multimedia data) requiring a guaranteed bandwidth occurs, so that QoS of multimedia data is guaranteed.

In addition, TCP traffic congestion control is possible by operations only in a MAC layer, and therefore, it is not necessary to change an upper application depending on a change in the MAC layer. As a result, the present invention guarantees compatibility with conventional applications.

1. A method of dynamically controlling traffic in a wireless station, the method comprising:
(a) reading header information of a packet received from an upper layer and determining a type of the packet from the header information;
(b) setting a priority according to the type of the packet;
(c) adjusting a size of a variable buffer by performing dynamic buffering according to the type of the packet;
(d) enqueuing the packet in a fixed buffer if the priority is high and enqueuing the packet in the variable buffer if the priority is low; and
(e) transmitting a packet enqueued in the fixed buffer to a destination station prior to a packet enqueued in the variable buffer.

2. The method of claim 1, wherein the type of the packet is a User Datagram Protocol (UDP) or a Transmission Control Protocol (TCP), and the UDP has priority over the TCP.

3. The method of claim 2, wherein the type of the packet is identified from information recorded in a protocol number field in an Internet Protocol (IP) header.

4. The method of claim 2, wherein when the type of the packet is the UDP, operation (c) comprises:
(c-1) comparing a number of consecutive non-TCP packets with a predetermined TCP threshold; and
(c-2) adjusting the size of the variable buffer according to a result of the comparison.

5. The method of claim 4, wherein operation (c-2) comprises:
minimizing the size of the variable buffer when the number of consecutive non-TCP packets is greater than or equal to the predetermined TCP threshold; and
decreasing the size of the variable buffer by one unit when the number of consecutive non-TCP packets is less than the predetermined TCP threshold.

6. The method of claim 2, wherein when the type of the packet is the TCP, operation (c) comprises:
(c-1) comparing a number of consecutive non-UDP packets with a predetermined UDP threshold; and
(c-2) adjusting the size of the variable buffer according to a result of the comparison.

7. The method of claim 6, wherein operation (c-2) comprises:
increasing the size of the variable buffer by one unit when the number of consecutive non-UDP packets is greater than or equal to the predetermined UDP threshold; and
discarding the TCP packet that cannot be accommodated by the variable buffer when the number of consecutive non-UDP packets is less than the predetermined UDP threshold.

8. The method of claim 7, wherein the discarding of the TCP packet comprises decreasing a size of a sliding window to decrease TCP traffic.

9. The method of claim 1, further comprising:
receiving an acknowledgement (ACK) frame corresponding to the packet from the destination station; and
equeuing a packet stored in the fixed buffer in a Medium Access Control (MAC) transmission buffer and enqueuing a packet stored in the variable buffer in the MAC transmission buffer when the fixed buffer has no packets to be transmitted.

10. The method of claim 2, wherein operation (e) comprises:
immediately transmitting the packet enqueued in the fixed buffer to a physical layer without backoff and transmitting the packet enqueued in the variable buffer to the physical layer after holding the packet for a predetermined backoff time; and
converting digital data included in the packet received by the physical layer into an analog radio frequency (RF) signal and transmitting the analog RF signal to another station through a wireless medium.

11. A wireless station for dynamically controlling traffic, the wireless station comprising:
a priority bit setting unit that reads header information of a packet received from an upper layer, determines a type of the packet, and sets a priority according to the type of the packet;
a dynamic buffering unit that adjusts a size of a variable buffer by performing dynamic buffering according to the type of the packet;
a fixed buffer that enqueues a packet having high priority;
a variable buffer that enqueues a packet having low priority; and
a transmission unit that transmits the packet enqueued in the fixed buffer to a destination station prior to the packet enqueued in the variable buffer.

12. The wireless station of claim 11, wherein the type of the packet is a User Datagram Protocol (UDP) or a Transmission Control Protocol (TCP), and the UDP has priority over the TCP.

13. The wireless station of claim 12, wherein the type of the packet is identified from information recorded in a protocol number field in an Internet Protocol (IP) header.

14. The wireless station of claim 12, wherein when the type of the packet is the UDP, the dynamic buffering unit compares a number of consecutive non-TCP packets with a predetermined TCP threshold, and adjusts the size of the variable buffer according to a result of the comparison.

15. The wireless station of claim 14, wherein the dynamic buffering unit adjusts the size of the variable buffer by minimizing the size of the variable buffer when the number of consecutive non-TCP packets is greater than or equal to the predetermined TCP threshold, and decreasing the size of the variable buffer by one unit when the number of consecutive non-TCP packets is less than the predetermined TCP threshold.

16. The wireless station of claim 12, wherein when the type of the packet is the TCP, the dynamic buffering unit adjusts the size of the variable buffer by comparing a number of consecutive non-UDP packets with a predetermined UDP threshold, and adjusting the size of the variable buffer according to a result of the comparison.

17. The wireless station of claim 16, wherein the dynamic buffering unit adjusts the size of the variable buffer by increasing the size of the variable buffer by one unit when the number of consecutive non-UDP packets is greater than or equal to the predetermined UDP threshold, and discarding the TCP packet that cannot be accommodated by the variable buffer when the number of consecutive non-UDP packets is less than the predetermined UDP threshold.

18. The wireless station of claim 17, further comprising a TCP module that decreases a size of a sliding window by discarding the TCP packet to decrease TCP traffic.

19. The wireless station of claim 11, further comprising a backoff determiner that receives an acknowledgement (ACK) frame corresponding to the packet from the destination station,
wherein a packet stored in the fixed buffer is enqueued in a Medium Access Control (MAC) transmission buffer and a packet stored in the variable buffer is enqueued in the MAC transmission buffer when the fixed buffer has no packets to be transmitted.

20. The wireless station of claim 12, wherein the transmitting unit comprises:
a lower MAC module that immediately transmits the packet enqueued in the fixed buffer to a physical layer without backoff and transmits the packet enqueued in the variable buffer to the physical layer after holding the packet for a predetermined backoff time; and
a physical layer module that converts digital data included in the packet received by the physical layer into an analog radio frequency (RF) signal and transmitting the analog RF signal to another station through a wireless medium.

21. A recording medium having a program recorded therein to be readable by a computer, the program for causing the computer to execute the method of claim 1.
